(19) United States
(12) Patent Application Publication
(10) Pub. No.: US 2026/0291324 A1
(43) Pub. Date: Sep. 24, 2026

(54) MOTOR-DRIVEN COMPRESSOR

(71) Applicant: KABUSHIKI KAISHA TOYOTA JIDOSHOKKI, Kariya-shi (JP)

(72) Inventors: Daichi YASUSHIMA, Kariya-shi (JP); Yumin HISHINUMA, Kariya-shi (JP); Shiro HAYASHI, Kariya-shi (JP)

(73) Assignee: KABUSHIKI KAISHA TOYOTA JIDOSHOKKI, Kariya-shi (JP)

(21) Appl. No.: 19/565,660

(22) Filed: Mar. 13, 2026

(30) Foreign Application Priority Data
Mar. 21, 2025 (JP) 2025-046615

(51) Int. Cl. H02K 5/22; H02K 11/33; F25B 31/02

(52) U.S. Cl. CPC H02K 5/225; H02K 11/33; F25B 31/026

(57) ABSTRACT

A motor-driven compressor includes a hermetic terminal that electrically connects a motor to an inverter. The hermetic terminal includes a conductive member that passes through a through-hole in a partition wall that separates the motor chamber from the inverter chamber, the conductive member having a first end and a second end electrically connected to the motor and the inverter, respectively, a support plate configured to support the conductive member, a seal portion including an annular bead configured to seal around the through-hole, and a fastener configured to fasten the support plate to the partition wall. A support portion configured to support a portion of the support plate located on an opposite side of the fastener from the bead is interposed between the support plate and the partition wall.

### CROSS-REFERENCE TO RELATED APPLICATIONS

This application is based upon and claims the benefit of priority from Japanese Patent Application No. 2025-046615, filed on Mar. 21, 2025, the entire contents of which are incorporated herein by reference.

### BACKGROUND

### 1. Field

The present disclosure relates to a motor-driven compressor.

### 2. Description of Related Art

Motor-driven compressors include a compression unit, a motor, an inverter, and a housing. The compression unit compresses fluid. The motor drives the compression unit. The inverter drives the motor. The housing defines a motor chamber and an inverter chamber. The motor chamber accommodates the motor, and fluid is drawn into the motor chamber. The inverter chamber accommodates the inverter. The housing includes a partition wall that separates the motor chamber from the inverter chamber. The partition wall has a through-hole.

The motor-driven compressor includes a hermetic terminal. The hermetic terminal includes a conductive member, a support plate, and a fastener. The conductive member passes through the through-hole. The first end of the conductive member is electrically connected to the motor. The second end of the conductive member is electrically connected to the inverter. The support plate supports the conductive member. The fastener fastens the support plate to the partition wall.

JP2018-145852A discloses a hermetic terminal that includes a seal portion. The seal portion includes an annular bead. The bead seals a space between the support plate and the partition wall around the through-hole.

For example, when the support plate is pressed toward the partition wall by a fastening force of a fastener, a reaction force from the bead is applied to the support plate. The support plate includes a first portion that overlaps the fastener in a thickness direction of the support plate and thus directly receives the fastening force of the fastener. The support plate includes a second portion that overlaps, in the thickness direction of the support plate, a portion of the bead adjacent to the fastener. The support plate includes a third portion located on an opposite side of the second portion from the first portion. The first portion serves as a point of effort in the lever principle, and the second portion serves as a fulcrum in the lever principle. Accordingly, the third portion is deformed to move away from the partition wall by the fastening force of the fastener. As a result, sealing performance between the support plate and the partition wall provided by the bead is reduced. Consequently, reliability of the motor-driven compressor is reduced.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A motor-driven compressor according to an aspect of the present disclosure includes a compression unit configured to compress fluid, a motor configured to drive the compression unit, an inverter configured to drive the motor, a housing including a motor chamber which accommodates the motor and into which fluid is drawn, an inverter chamber that accommodates the inverter, and a partition wall that separates the motor chamber from the inverter chamber, and a hermetic terminal that electrically connects the motor to the inverter while blocking passage of fluid between the motor chamber and the inverter chamber. The partition wall has a through-hole. The hermetic terminal includes a conductive member that passes through the through-hole, the conductive member having a first end electrically connected to the motor and a second end electrically connected to the inverter, a support plate configured to support the conductive member, a seal portion including an annular bead, the bead being configured to seal around the through-hole, and a fastener configured to fasten the support plate to the partition wall. A support portion is interposed between the support plate and the partition wall. The support portion is configured to support a portion of the support plate located on an opposite side of the fastener from the bead.

Other features and aspects will be apparent from the following detailed description, the drawings, and the claims.

### BRIEF DESCRIPTION OF THE DRAWINGS

FIG. 1 is a cross-sectional view of a motor-driven compressor according to an embodiment.

FIG. 2 is an enlarged cross-sectional view illustrating a portion of the motor-driven compressor shown in FIG. 1.

FIG. 3 is an exploded perspective view showing a portion of the motor-driven compressor of FIG. 1.

FIG. 4 is an exploded perspective view showing a portion of the motor-driven compressor of FIG. 1.

FIG. 5 is a plan view of a portion of the end wall of the motor housing member shown in FIG. 3.

FIG. 6 is an enlarged cross-sectional view illustrating a portion of the motor-driven compressor shown in FIG. 1.

FIG. 7 is an exploded perspective view showing a portion of the motor-driven compressor according to a first modification.

FIG. 8 is a plan view illustrating the support portions in the first modification.

FIG. 9 is an exploded perspective view showing a portion of the motor-driven compressor according to a second modification.

FIG. 10 is a plan view illustrating the support portions in the second modification.

FIG. 11 is an exploded perspective view showing a portion of the motor-driven compressor according to a third modification.

FIG. 12 is a plan view illustrating the support portions in the third modification.

FIG. 13 is a plan view illustrating the support portions in a fourth modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

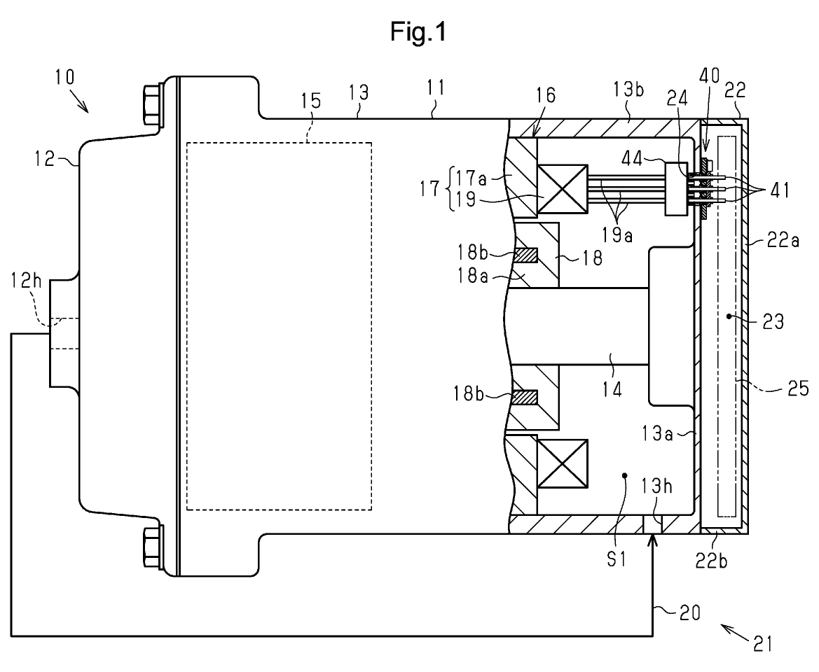

A motor-driven compressor 10 according to an embodiment will now be described with reference to FIGS. 1-6. The motor-driven compressor 10 of the present embodiment is used, for example, in a vehicle air conditioner.

### Overview of Motor-Driven Compressor

As shown in FIG. 1, the motor-driven compressor 10 includes a housing 11. The housing 11 includes a discharge housing member 12 and a motor housing member 13. The discharge housing member 12 and the motor housing member 13 are cylindrical. The motor housing member 13 is coupled to the discharge housing member 12. The discharge housing member 12 and the motor housing member 13 are made of metal. The discharge housing member 12 and the motor housing member 13 are made of, for example, aluminum. The motor housing member 13 includes a flat end wall 13a and a cylindrical peripheral wall 13b. The peripheral wall 13b extends from the outer periphery of the end wall 13a.

The motor-driven compressor 10 includes a rotary shaft 14. The rotary shaft 14 is accommodated in the motor housing member 13. Thus, the rotary shaft 14 is accommodated in the housing 11. The rotary shaft 14 is rotatably supported by the motor housing member 13. This allows the rotary shaft 14 to be rotatably supported by the housing 11.

The motor-driven compressor 10 includes a compression unit 15 and a motor 16. The compression unit 15 and the motor 16 are accommodated in the motor housing member 13. Thus, the housing 11 accommodates the compression unit 15 and the motor 16. The compression unit 15 and the motor 16 are arranged in an axial direction of the rotary shaft 14, in which a rotational axis of the rotary shaft 14 extends. The motor 16 is disposed between the compression unit 15 and the end wall 13a of the motor housing member 13. In the motor housing member 13, the space between the compression unit 15 and the end wall 13a serves as a motor chamber S1 that accommodates the motor 16. Thus, the housing 11 defines the motor chamber S1.

Rotation of the rotary shaft 14 drives the compression unit 15. The compression unit 15 compresses refrigerant, which is fluid. The compression unit 15 is, for example, of a scroll type that includes a fixed scroll (not shown) fixed inside the motor housing member 13 and an orbiting scroll (not shown) opposed to the fixed scroll. Examples of the refrigerant compressed by the compression unit 15 include natural refrigerants, such as carbon dioxide and propane.

The motor 16 includes a cylindrical stator 17 and a cylindrical rotor 18. The rotor 18 is located on the inner side of the stator 17. The rotor 18 is configured to rotate integrally with the rotary shaft 14. The rotor 18 includes a rotor core 18a and permanent magnets 18b. The rotor core 18a is fixed to the rotary shaft 14. The permanent magnets 18b are arranged in the rotor core 18a. The stator 17 surrounds the rotor 18. The stator 17 includes a cylindrical stator core 17a and motor coils 19. The motor coils 19 are wound around the stator core 17a. The motor coils 19 include three motor coils 19, namely, U-phase, V-phase, and W-phase motor coils 19. When power is supplied to the motor coils 19, the rotor 18 is rotated, and the rotary shaft 14 is rotated integrally with the rotor 18. The compression unit 15 is driven by rotation of the rotary shaft 14. In this manner, the motor 16 drives the compression unit 15.

The motor-driven compressor 10 includes motor wires 19a. The motor wires 19a are drawn out of the motor coils 19 of the motor 16. Specifically, three motor wires 19a corresponding to the U-phase, V-phase, and W-phase motor coils 19 are drawn out from portions of the motor coils 19 that face the end wall 13a of the motor housing member 13. Each motor wire 19a is a portion of a winding forming part of the motor coil 19, the portion being drawn out from the motor coil 19 while being covered with an insulating coating.

The housing 11 includes a suction port 13h. The suction port 13h is located in a section of the peripheral wall 13b of the motor housing member 13 closer to the end wall 13a. The suction port 13h draws refrigerant into the motor chamber S1. Thus, refrigerant is drawn into the motor chamber S1. The suction port 13h is connected to the first end of an external refrigerant circuit 20. The housing 11 includes a discharge port 12h. The discharge port 12h is formed in the discharge housing member 12. The discharge port 12h is connected to the second end of the external refrigerant circuit 20. The motor-driven compressor 10 and the external refrigerant circuit 20 form a vehicle air conditioner 21.

The motor-driven compressor 10 includes an inverter cover 22. The inverter cover 22 is a part of the housing 11. Thus, the housing 11 includes an inverter cover 22.

The inverter cover 22 includes a flat cover end wall 22a and a cylindrical cover peripheral wall 22b. The cover peripheral wall 22b extends from the outer periphery of the cover end wall 22a. The cover peripheral wall 22b has an opening end on the side opposite to the cover end wall 22a. The opening end of the cover peripheral wall 22b is coupled to the end wall 13a of the motor housing member 13, so that the inverter cover 22 is coupled to the motor housing member 13. The thickness direction of the cover end wall 22a corresponds to the thickness direction of the end wall 13a. The inverter chamber 23 is defined by the end wall 13a, the cover end wall 22a, and the cover peripheral wall 22b. Thus, the housing 11 defines the inverter chamber 23. The end wall 13a serves as a partition wall that separates the motor chamber S1 from the inverter chamber 23.

The end wall 13a has a through-hole 24. The through-hole 24 extends through the end wall 13a in the thickness direction of the end wall 13a. The through-hole 24 is formed in the end wall 13a at a position outward from the center of the end wall 13a in the radial direction of the rotary shaft 14. The first end of the through-hole 24 opens toward the motor chamber S1. The second end of the through-hole 24 opens toward the inverter chamber 23.

The motor-driven compressor 10 includes an inverter 25. The inverter 25 is accommodated in the inverter chamber 23. Thus, the inverter chamber 23 accommodates the inverter 25. The inverter 25 drives the motor 16. The compression unit 15, the motor 16, and the inverter 25 are arranged in this order in the axial direction of the rotary shaft 14. In this manner, the housing 11 accommodates the compression unit 15, the motor 16, and the inverter 25.

### Hermetic Terminal

The motor-driven compressor 10 includes a hermetic terminal 40. The hermetic terminal 40 is disposed on the end wall 13a of the motor housing member 13. Accordingly, the hermetic terminal 40 is disposed in the housing 11. The hermetic terminal 40 electrically connects the motor 16 to the inverter 25 while providing a seal between the motor chamber S1 and the inverter chamber 23. That is, the hermetic terminal 40 electrically connects the motor 16 to the inverter 25 while blocking passage of fluid between the motor chamber S1 and the inverter chamber 23.

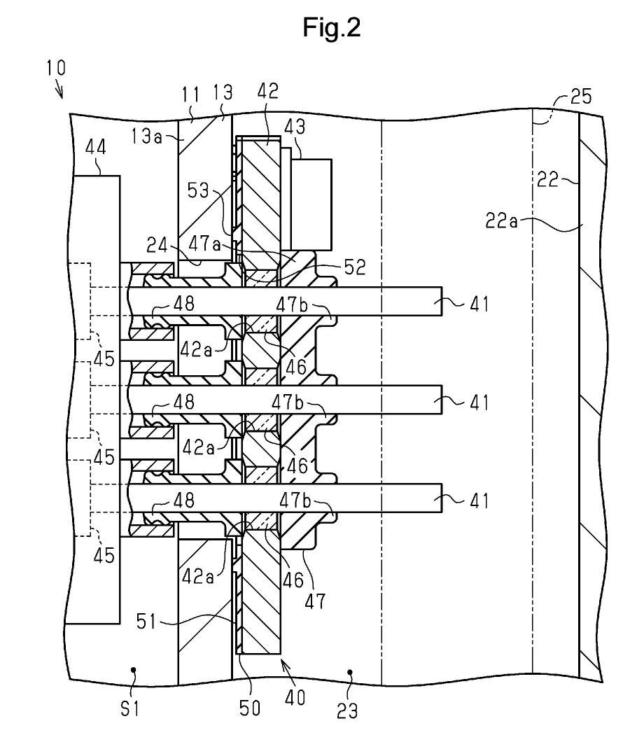

As shown in FIGS. 2, 3, and 4, the hermetic terminal 40 includes conductive members 41, a support plate 42, a seal portion 50, and fasteners 43. The conductive members 41 are formed from a conductive material. The hermetic terminal 40 includes three conductive members 41 corresponding to the three motor coils 19 of the U-phase, the V-phase, and the W-phase. Each conductive member 41 is a cylindrical metal pin extending straight. Each conductive member 41 passes through the through-hole 24. The conductive members 41 extend in parallel to each other. The first end of each conductive member 41 protrudes into the motor chamber S1 through the through-hole 24. The second end of each conductive member 41 protrudes into the inverter chamber 23 through the through-hole 24.

As shown in FIG. 1, the motor-driven compressor 10 includes a cluster block 44. The ends of the motor wires 19a are connected to the cluster block 44. As shown in FIG. 2, the cluster block 44 includes connection terminals 45.

As shown in FIG. 2, the first end of each conductive member 41 is connected to a corresponding connection terminal 45, which is located in the cluster block 44. The first end of each conductive member 41 is electrically connected to a corresponding motor wire 19a via a corresponding connection terminal 45. Accordingly, the first end of each conductive member 41 is electrically connected to the motor 16. The second end of each conductive member 41 is electrically connected to the inverter 25. Thus, the first end of each conductive member 41 is electrically connected to the motor 16, and the second end of each conductive member 41 is electrically connected to the inverter 25.

As shown in FIGS. 2, 3 and 4, the support plate 42 is flat. The support plate 42 is made of metal. The support plate 42 is made of, for example, steel. In plan view, the support plate 42 has an elongated rectangular flat shape.

As shown in FIG. 2, the support plate 42 has three plate through-holes 42a. Each plate through-hole 42a extends through the support plate 42 in the thickness direction of the support plate 42. The plate through-holes 42a are aligned in the longitudinal direction of the support plate 42. Each conductive member 41 extends through a corresponding plate through-hole 42a.

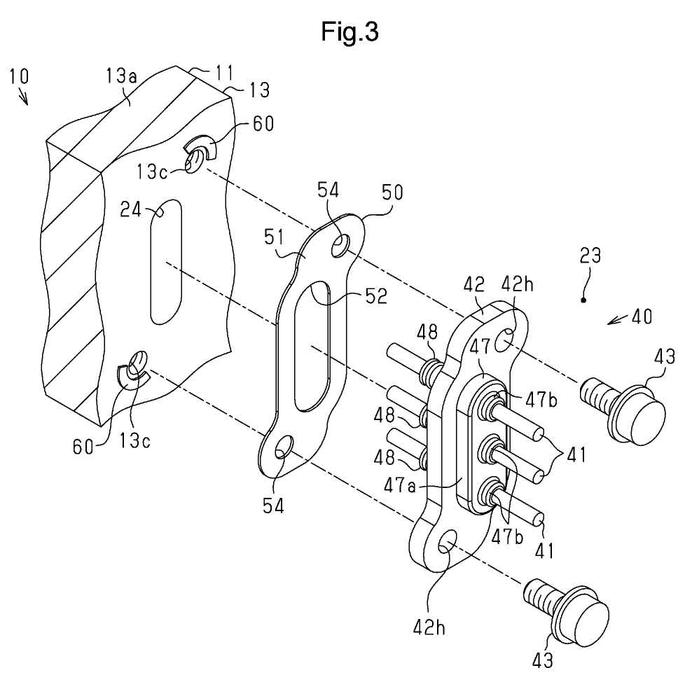

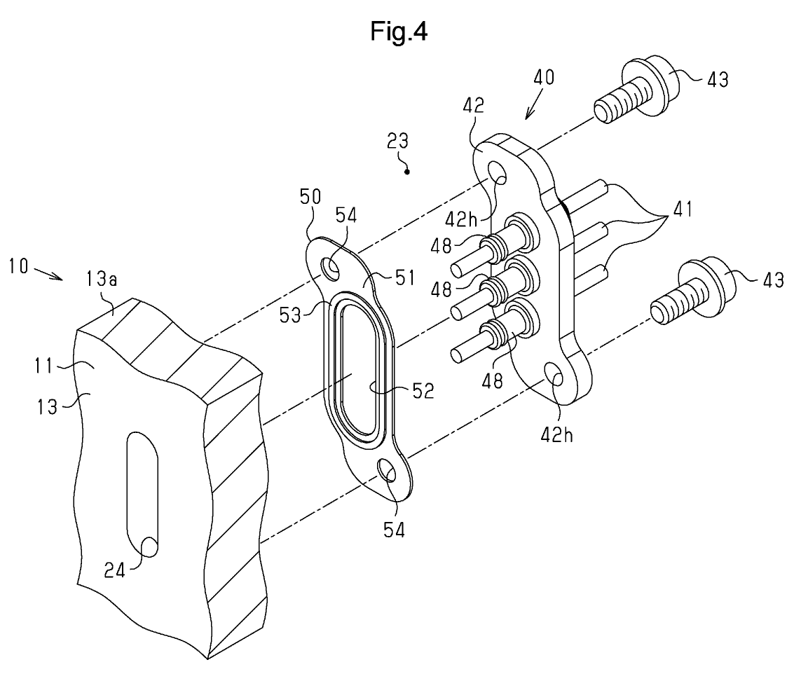

As shown in FIGS. 3 and 4, the support plate 42 has two plate holes 42h. Each plate hole 42h is circular. Each plate hole 42h extends through the support plate 42 in the thickness direction of the support plate 42. As the support plate 42 is viewed in the thickness direction, the two plate holes 42h are disposed on the opposite sides of a group of the three conductive members 41, at corners positioned on a diagonal line of the support plate 42.

As shown in FIG. 2, the hermetic terminal 40 includes three glass members 46 corresponding to the respective conductive members 41. Each glass member 46 is disposed in a corresponding plate through-hole 42a. Each glass member 46 is made of insulating glass. Each glass member 46 is interposed between a corresponding conductive member 41 and the support plate 42. Each glass member 46 insulates and seals a space between a corresponding conductive member 41 and the support plate 42. The support plate 42 supports each conductive member 41, with the conductive member 41 insulated from the support plate 42 by a corresponding glass member 46.

The hermetic terminal 40 includes a first insulator 47. The first insulator 47 is made of rubber. The first insulator 47 is disposed on a surface of the support plate 42 on the side opposite to the end wall 13a of the motor housing member 13.

The first insulator 47 includes a flat base 47a and three tubular portions 47b. The base 47a is disposed on the support plate 42 in close contact with the support plate 42. Each tubular portion 47b has a cylindrical shape and protrudes from a surface of the base 47a on the side opposite to the support plate 42. Each conductive member 41 extends through a corresponding tubular portion 47b and the base 47a. The first insulator 47 insulates the support plate 42 from each conductive member 41.

The hermetic terminal 40 includes three second insulators 48. Each second insulator 48 is made of rubber. Each second insulator 48 is tubular. Each conductive member 41 extends through a corresponding second insulator 48. Each second insulator 48 covers a portion of a corresponding conductive member 41 that protrudes from the support plate 42, the portion being located inside the through-hole 24. Each second insulator 48 insulates a corresponding conductive member 41 from the end wall 13a of the motor housing member 13.

As shown in FIG. 3, two internally threaded holes 13c are formed in a surface of the end wall 13a of the motor housing member 13 that defines the inverter chamber 23. The internally threaded holes 13c are each arranged at a position around the through-hole 24 on the surface of the end wall 13a that defines the inverter chamber 23.

As shown in FIGS. 2, 3 and 4, the seal portion 50 is a gasket. The seal portion 50 includes a flat seal body 51. The seal body 51 has an elongated quadrangular plate shape in plan view. The seal body 51 is interposed between the support plate 42 and the end wall 13a of the motor housing member 13. The thickness direction of the seal body 51 coincides with the thickness direction of the end wall 13a and the thickness direction of the support plate 42. The first surface of the seal body 51 faces the end wall 13a. The second surface of the seal body 51 faces the support plate 42. The second surface of the seal body 51 is in close contact with the support plate 42.

The seal portion 50 has a seal through-hole 52. The seal through-hole 52 extends through the seal body 51 in the thickness direction of the seal body 51. The seal through-hole 52 is elongated. The longitudinal direction of the seal through-hole 52 coincides with the longitudinal direction of the seal body 51. The first end of the seal through-hole 52 opens in the first surface of the seal body 51. The first end of the seal through-hole 52 opens into the through-hole 24. The second end of the seal through-hole 52 opens in the second surface of the seal body 51. The second end of the seal through-hole 52 opens into each plate through-hole 42a. The conductive members 41 extend through the seal through-hole 52.

As shown in FIG. 4, the seal portion 50 includes an annular bead 53. The bead 53 protrudes from the first surface of the seal body 51. In plan view of the first surface of the seal body 51, the bead 53 surrounds the seal through-hole 52.

As shown in FIG. 2, the bead 53 is in close contact with the periphery of the through-hole 24 in the end wall 13a of the motor housing member 13. This allows the bead 53 to seal the periphery of the through-hole 24 between the support plate 42 and the end wall 13a.

As shown in FIGS. 3 and 4, the seal portion 50 has two seal holes 54. Each seal hole 54 is circular. Each seal hole 54 extends through the seal body 51 in the thickness direction of the seal body 51. As the seal body 51 is viewed in the thickness direction, the two seal holes 54 are disposed on the opposite sides of the bead 53, at corners positioned on a diagonal line of the seal body 51. Each seal hole 54 allows a corresponding internally threaded hole 13c to open into a corresponding plate hole 42h.

The fasteners 43 are bolts. Each fastener 43 is configured to pass through a plate hole 42h and a seal hole 54 and to be screwed into a corresponding internally threaded hole 13c of the motor housing member 13. Each fastener 43 passing through a plate hole 42h and a seal hole 54 is screwed into a corresponding internally threaded hole 13c, so that the support plate 42 is fastened to the end wall 13a together with the seal portion 50 by the fastener 43. Thus, the fasteners 43 fasten the support plate 42 to the end wall 13a.

As viewed in the thickness direction of the support plate 42, the two fasteners 43 are disposed on the opposite sides of the group of the three conductive members 41, at corners positioned on a diagonal line of the support plate 42. Accordingly, as viewed in the thickness direction of the support plate 42, the fasteners 43 are each arranged on a corresponding side of the group of the three conductive members 41.

As shown in FIG. 2, the support plate 42 and the seal portion 50 are fixed to the end wall 13a of the motor housing member 13 while being disposed in the inverter chamber 23. Accordingly, the support plate 42 and the seal portion 50 are disposed in the inverter chamber 23.

### Support Portions

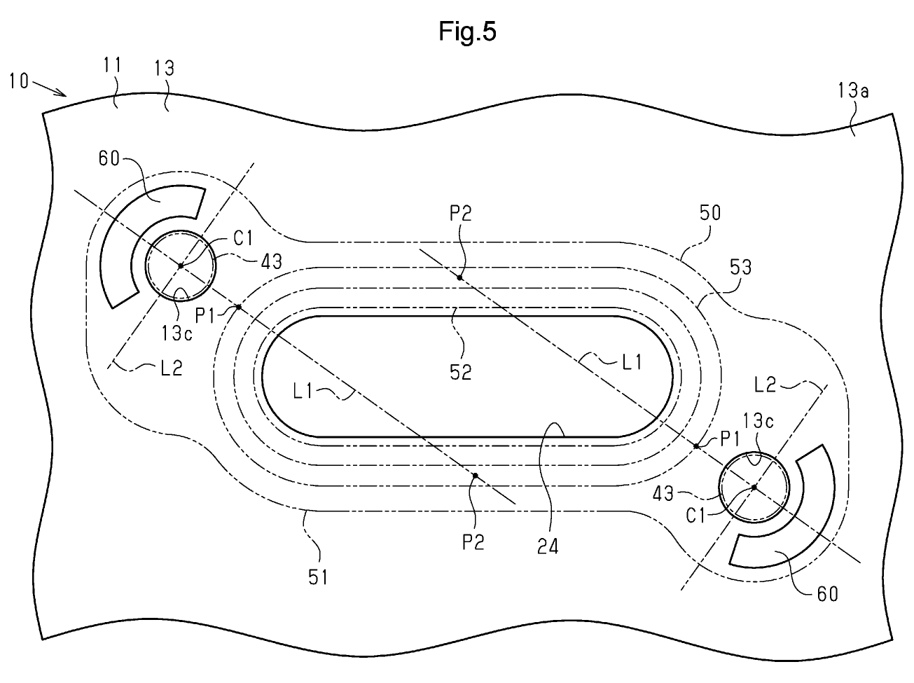

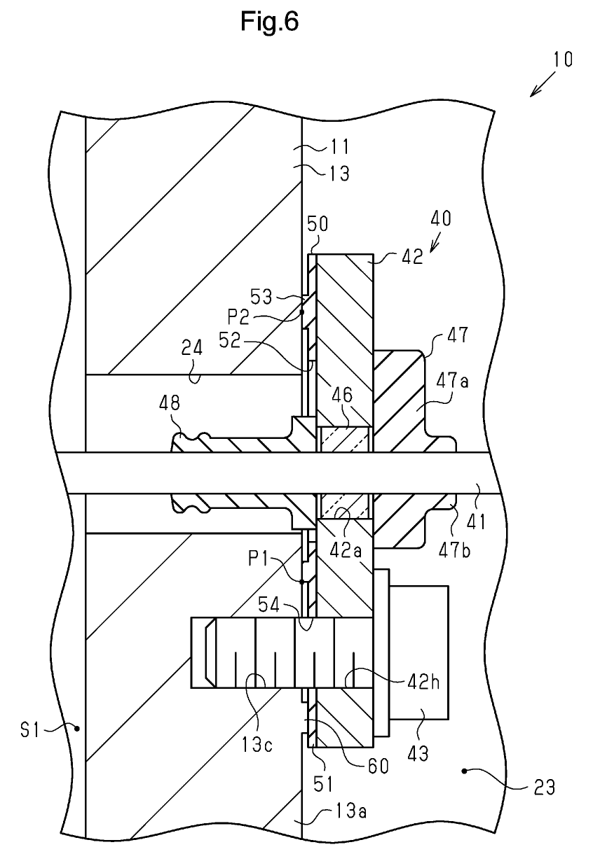

As shown in FIGS. 5 and 6, support portions 60 are interposed between the support plate 42 and the end wall 13a of the motor housing member 13. The end wall 13a is provided with two support portions 60. Each support portion 60 protrudes from the end wall 13a toward the support plate 42. Each support portion 60 is a columnar projection that protrudes from the end wall 13a. Each support portion 60 is formed integrally with the end wall 13a. The protrusion height of each support portion 60 from the end wall 13a is slightly lower than the protrusion height of the bead 53 from the first surface of the seal body 51 when the seal portion 50 is in an undeformed state. Each support portion 60 is interposed between the end wall 13a and the seal portion 50.

As shown in FIG. 5, each support portion 60 has a semicircular arc shape centered on the center C1 of a corresponding fastener 43. The center C1 of each fastener 43 is the axis of a bolt. The center C1 of each fastener 43 is also the center of a corresponding internally threaded hole 13c. The portion of the bead 53 that is adjacent to each fastener 43 at the shortest distance is referred to as a first portion P1. The straight line passing through the center C1 of each fastener 43 and passing through a corresponding first portion P1 of the bead 53, as viewed in the thickness direction of the seal body 51, is referred to as a first straight line L1. The straight line passing through the center C1 of each fastener 43 and extending in a direction orthogonal to a corresponding first straight line L1, as viewed in the thickness direction of the seal body 51, is referred to as a second straight line L2.

Each support portion 60 protrudes toward the support plate 42 from a portion of the end wall 13a of the motor housing member 13 that is located adjacent to a corresponding fastener 43 and on the opposite side of the second straight line L2 from the bead 53. Each support portion 60 protrudes toward the support plate 42 from a portion of the end wall 13a that is located adjacent to a corresponding internally threaded hole 13c and on the opposite side of the second straight line L2 from the through-hole 24. The portion of the support plate 42 on the opposite side of each fastener 43 from the bead 53 is referred to as a first portion of the support plate 42. Each support portion 60 supports a corresponding first portion of the support plate 42.

The portion of the bead 53 that lies on a first straight line L1 and on the opposite side of a first portion P1 of the bead 53 from a fastener 43 is referred to as a second portion P2. The portion of the support plate 42 that overlaps each second portion P2 of the bead 53 in the thickness direction of the support plate 42 is referred to as a second portion of the support plate 42. No internally threaded hole 13a is formed in a portion of the end wall 13a that lies on the first straight line L1 and on the opposite side of the bead 53 from a fastener 43. This prevents the second portion of the support plate 42 from being fastened to the end wall 13a by the fastener 43.

### Operation of the Embodiment

The operation of the present embodiment will now be described.

The power from the inverter 25 is supplied to the motor coils 19 via the conductive members 41, the connection terminals 45, and the motor wires 19a. This rotates the rotary shaft 14 integrally with the rotor 18. The compression unit 15 is driven by the rotation of the rotary shaft 14.

Refrigerant that has been drawn into the motor chamber S1 from the first end of the external refrigerant circuit 20 through the suction port 13h is compressed by the compression unit 15 when the compression unit 15 is driven. The refrigerant compressed by the compression unit 15 flows to the second end of the external refrigerant circuit 20 through the discharge port 12h. The refrigerant that has flowed to the external refrigerant circuit 20 flows through a heat exchanger or an expansion valve that are included in the external refrigerant circuit 20. Then, the refrigerant flows through the suction port 13h and returns to the motor chamber S1.

The portion of the support plate 42 that overlaps each fastener 43 in the thickness direction of the support plate 42, that is, the portion that directly receives the fastening force of the fastener 43, is referred to as a third portion of the support plate 42. The portion of the support plate 42 that overlaps each first portion P1 of the bead 53 in the thickness direction of the support plate 42 is referred to as a fourth portion of the support plate 42. For example, it is assumed that the support plate 42 is pressed against the end wall 13a of the motor housing member 13 by the fastening forces of the fasteners 43 and reaction forces from the bead 53 are applied to the support plate 42. In this case, the support portions 60 support the first portions of the support plate 42. Thus, the fastening forces of the fasteners 43 applied to the support plate 42 are supported not only by the bead 53 but also by the support portions 60, each of which is located on the opposite side of a corresponding fastener 43 from the bead 53. Accordingly, the third portion of the support plate 42 is unlikely to function as a point of effort in the lever principle. As a result, the fourth portion of the support plate 42 is also unlikely to function as a fulcrum of the lever principle. Consequently, the second portion of the support plate 42 is less likely to be deformed away from the end wall 13a.

### Advantages of the Embodiment

The above embodiment provides the following advantages.
(1) Each support portion 60, which supports a corresponding first portion of the support plate 42, is interposed between the support plate 42 and the end wall 13a of the motor housing member 13. For example, it is assumed that the support plate 42 is pressed against the end wall 13a by the fastening forces of the fasteners 43 and reaction forces from the bead 53 are applied to the support plate 42. Even in such a case, each first portion of the support plate 42 is supported by a corresponding support portion 60. Accordingly, the third portion of the support plate 42 is unlikely to function as a point of effort in the lever principle. As a result, the fourth portion of the support plate 42 is also unlikely to function as a fulcrum of the lever principle. Consequently, the second portion of the support plate 42 is less likely to be deformed away from the end wall 13a. This increases the performance of the bead 53 in sealing the periphery of the through-hole 24 between the support plate 42 and the end wall 13a, thereby improving reliability of the motor-driven compressor 10.
(2) The support portions 60 are formed integrally with the end wall 13a of the motor housing member 13 and protrudes from the end wall 13a toward the support plate 42. Such a configuration is advantageous in that each support portion 60 is interposed between the support plate 42 and the end wall 13a and supports a corresponding first portion of the support plate 42.
(3) Since the support plate 42 is less likely to deform, stress is less likely to be applied to the glass members 46. As a result, the durability of the glass members 46 is improved. Consequently, the sealing performance of the glass members 46 is improved.
(4) The support portions 60 are formed integrally with the end wall 13a of the motor housing member 13. Accordingly, the support portions 60 are interposed between the support plate 42 and the end wall 13a without increasing the number of components.

### Modifications

The above embodiment may be modified as follows. The above embodiment and the following modifications can be combined as long as the combined modifications remain technically consistent with each other.

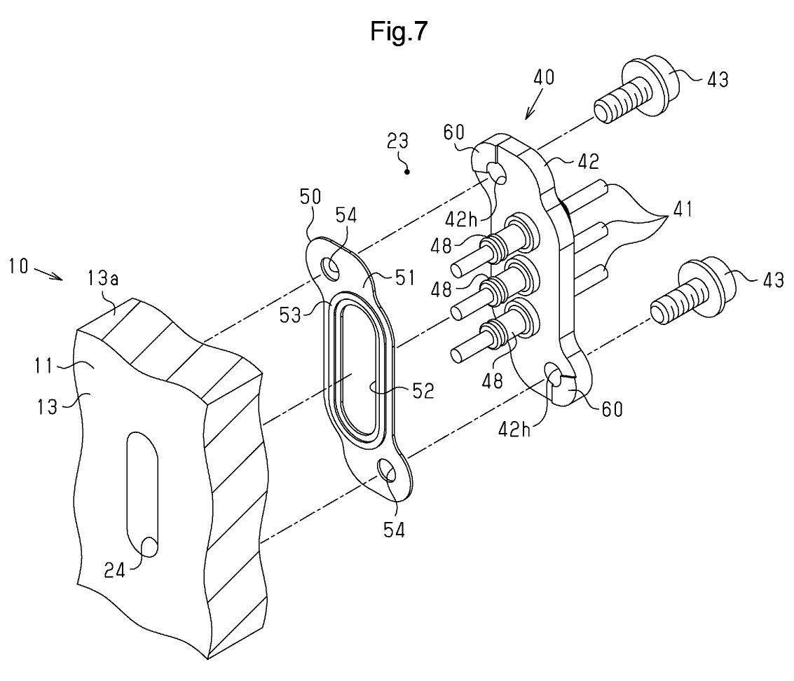

As shown in FIG. 7, the support portions 60 may be formed integrally with the support plate 42 and may protrude from the support plate 42 toward the end wall 13a of the motor housing member 13. In this manner, the support portions 60 may be interposed between the support plate 42 and the end wall 13a. The support plate 42 includes two support portions 60. The support portions 60 are interposed between the support plate 42 and the seal portion 50.

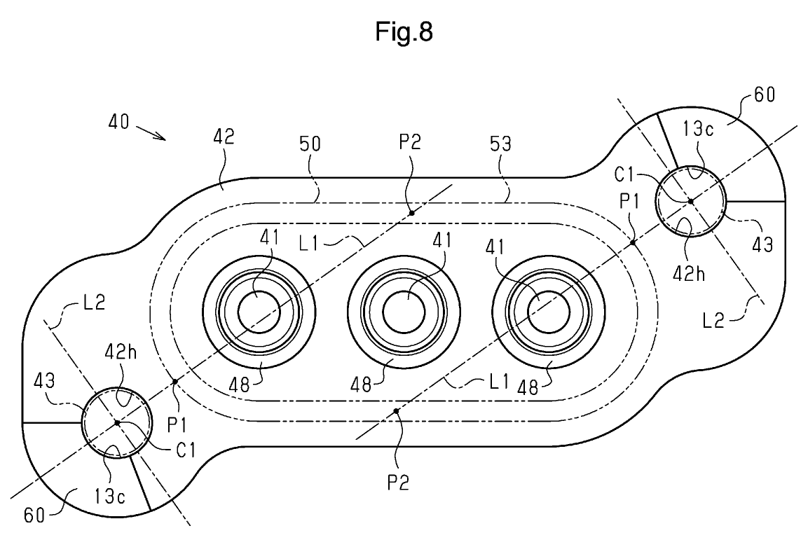

As shown in FIG. 8, each support portion 60 protrudes toward the end wall 13a of the motor housing member 13 from a portion of the support plate 42 that is located adjacent to a corresponding fastener 43 and on the opposite side of the second straight line L2 from the bead 53. Each support portion 60 protrudes toward the end wall 13a from a portion of the support plate 42 that is located adjacent to a corresponding plate hole 42h and on the opposite side of the second straight line L2 from the plate through-hole 42a. Each support portion 60 supports a corresponding first portion of the support plate 42.

For example, it is assumed that the support plate 42 is pressed against the end wall 13a of the motor housing member 13 by the fastening forces of the fasteners 43 and reaction forces from the bead 53 are applied to the support plate 42. In this case, each support portion 60 is pressed against the end wall 13a via the seal body 51. This allows each support portion 60 to support a corresponding first portion of the support plate 42. In this manner, the first portion of the support plate 42 may be supported by each support portion 60.

Such a configuration is advantageous in that each support portion 60 is interposed between the support plate 42 and the end wall 13a of the motor housing member 13 and supports a corresponding first portion of the support plate 42.

The support portions 60 are formed integrally with the support plate 42. Accordingly, the support portions 60 are interposed between the support plate 42 and the end wall 13a of the motor housing member 13 without increasing the number of components.

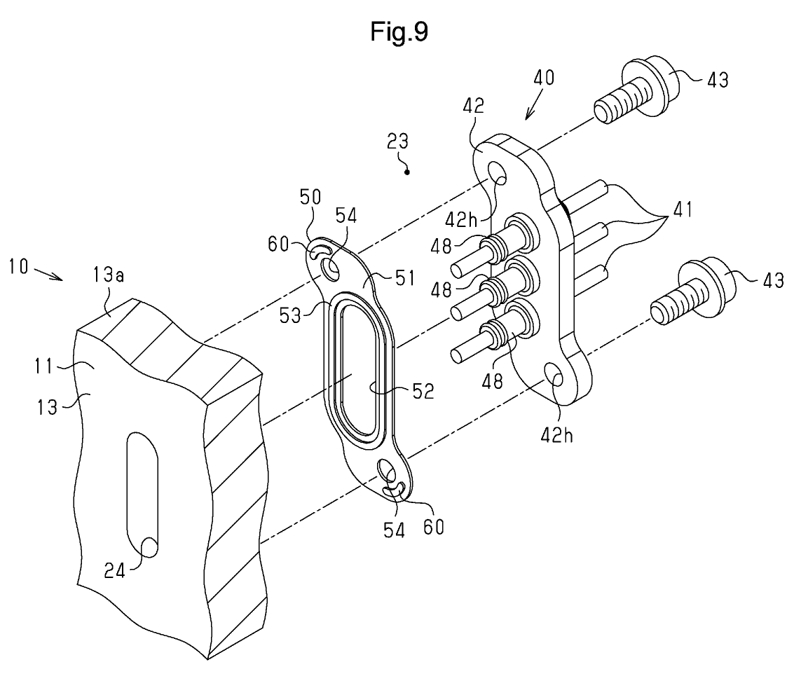

As shown in FIG. 9, the support portions 60 may be formed integrally with the seal portion 50 and protrude from the seal body 51 in the same direction as the bead 53. In this manner, the support portions 60 may be interposed between the support plate 42 and the end wall 13a of the motor housing member 13. The seal portion 50 includes two support portions 60. The support portions 60 are interposed between the seal portion 50 and the end wall 13a.

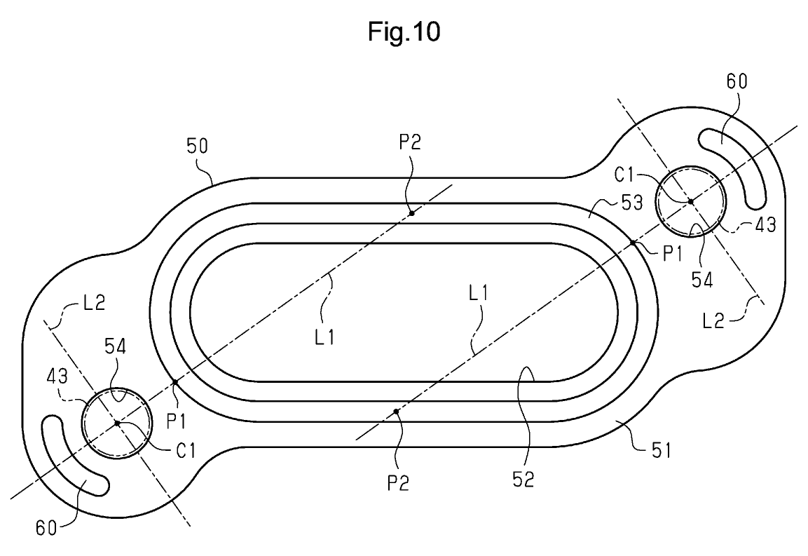

As shown in FIG. 10, each support portion 60 protrudes toward the end wall 13a of the motor housing member 13 from a portion of the seal body 51 that is located adjacent to a corresponding fastener 43 and on the opposite side of the second straight line L2 from the bead 53. Each support portion 60 protrudes toward the end wall 13a from a portion of the seal body 51 that is located adjacent to a corresponding seal hole 54 and on the opposite side of the second straight line L2 from the seal through-hole 52. Each support portion 60 supports a corresponding first portion of the support plate 42.

For example, it is assumed that the support plate 42 is pressed against the end wall 13a of the motor housing member 13 by the fastening forces of the fasteners 43 and reaction forces from the bead 53 are applied to the support plate 42. In this case, the support portions 60 are pressed against the end wall 13a, and reaction forces from the support portions 60 act on the first portions of the support plate 42. This allows each support portion 60 to support a corresponding first portion of the support plate 42. In this manner, the first portions of the support plate 42 may be supported by the support portions 60.

Such a configuration is advantageous in that each support portion 60 is interposed between the support plate 42 and the end wall 13a of the motor housing member 13 and supports a corresponding first portion of the support plate 42.

The support portions 60 are formed integrally with the seal portion 50. Accordingly, the support portions 60 are interposed between the support plate 42 and the end wall 13a of the motor housing member 13 without increasing the number of components.

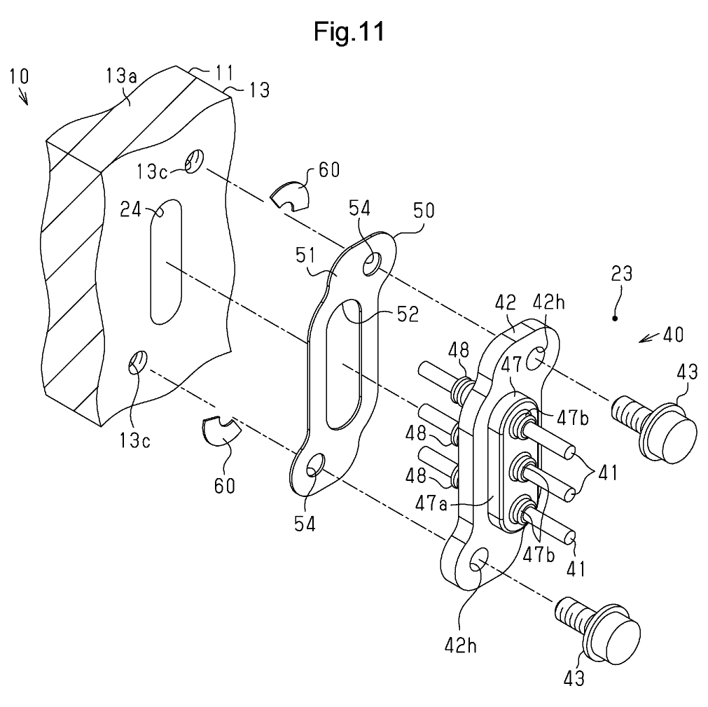

As shown in FIG. 11, the support portions 60 may be separate from the end wall 13a of the motor housing member 13, the support plate 42, and the seal portion 50. Two support portions 60 are interposed between the seal portion 50 and the end wall 13a. In this manner, the support portions 60 may be interposed between the support plate 42 and the end wall 13a.

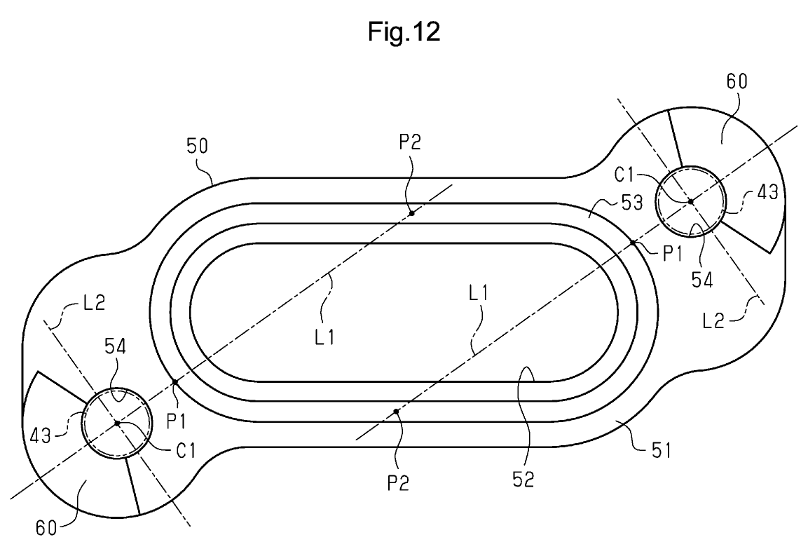

As shown in FIG. 12, each support portion 60 is disposed on the seal portion 50 so as to overlap a portion of the first surface of the seal body 51 that is located adjacent to a corresponding fastener 43 and on the opposite side of the second straight line L2 from the bead 53. Each support portion 60 supports a corresponding first portion of the support plate 42.

For example, it is assumed that the support plate 42 is pressed against the end wall 13a of the motor housing member 13 by the fastening forces of the fasteners 43 and reaction forces from the bead 53 are applied to the support plate 42. In this case, the support portions 60 support the first portions of the support plate 42. In this manner, the first portion of the support plate 42 may be supported by each support portion 60.

Such a configuration is advantageous in that each support portion 60 is interposed between the support plate 42 and the end wall 13a of the motor housing member 13 and supports a corresponding first portion of the support plate 42.

The support portions 60 are separate from the end wall 13a of the motor housing member 13, the support plate 42, and the seal portion 50. Accordingly, the support portions 60 are interposed between the support plate 42 and the end wall 13a without changing the configurations of the end wall 13a, the support plate 42, and the seal portion 50.

In the embodiment, the seal body 51 may include one seal through-hole 52 in correspondence with each of the three conductive members 41. The seal portion 50 may include multiple annular beads 53 that respectively surround the seal through-holes 52. In this configuration, each one of the beads 53 may protrude from the first surface of the seal body 51.

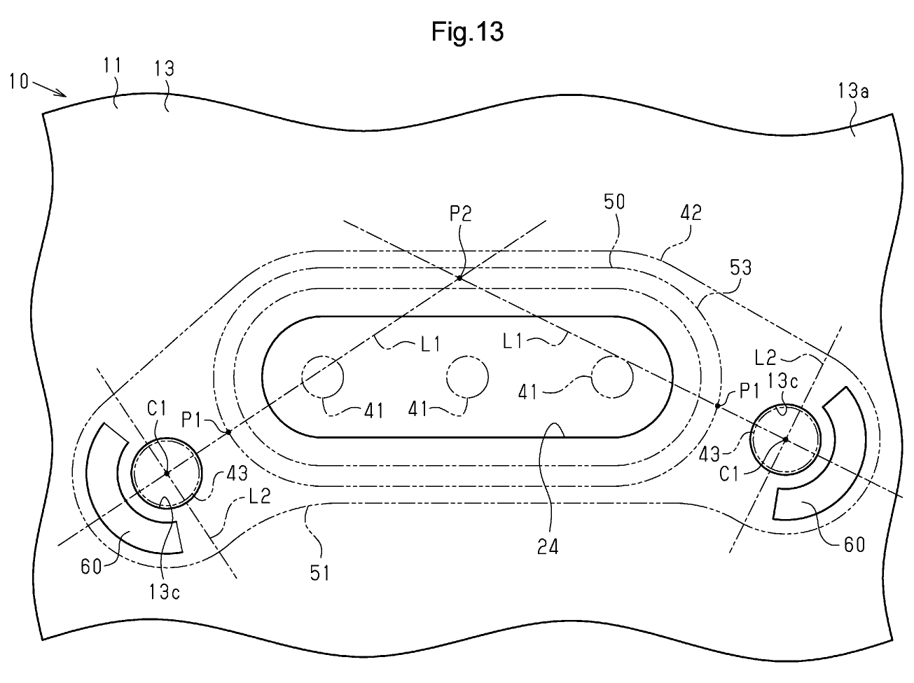

As shown in FIG. 13, as viewed in the thickness direction of the support plate 42, the two fasteners 43 may each be disposed on a corresponding one of the two longitudinal ends of the support plate 42 such that the three conductive members 41 are located between the two fasteners 43 in the longitudinal direction of the support plate 42 and the two fasteners 43 are aligned in the longitudinal direction of the support plate 42. The two fasteners 43 are not aligned on the same straight line as the three conductive members 41 in the longitudinal direction of the support plate 42. When the two fasteners 43 are arranged in the manner shown in FIG. 13, the two second portions P2 of the bead 53 overlap each other. In such a case, as compared to the embodiment, the second portions of the support plate 42 are more likely to be deformed away from the end wall 13a of the motor housing member 13. Even in such a case, each first portion of the support plate 42 is supported by a corresponding support portion 60. Consequently, the second portion of the support plate 42 is less likely to be deformed away from the end wall 13a.

In the embodiment, each fastener 43 may be arranged at a respective one of the four corners of the support plate 42. In short, at least one fastener 43 may be arranged on each of opposite sides of the group of the conductive members 41 when viewed in the thickness direction of the support plate 42.

In the embodiment, each fastener 43 may include a bolt and a nut into which the bolt is screwed. For example, the nut may be disposed in the inverter chamber 23. Further, the support plate 42 may be fastened to the end wall 13a by inserting the bolt from the motor chamber S1 through the end wall 13a of the motor housing member 13 and screwing the bolt into the nut. In this case, the support plate 42 and the seal portion 50 are arranged in the motor chamber S1.

In the embodiment, the support portions 60 have a semicircular arc shape centered on the center C1 of each fastener 43. However, the shapes of the support portions 60 are not limited thereto. It is sufficient that the support portions 60 are capable of supporting the first portions of the support plate 42.

In the embodiment, the protrusion height of each support portion 60 from the end wall 13a of the motor housing member 13 may be slightly higher than the protrusion height of the bead 53 from the first surface of the seal body 51 when the seal portion 50 is in an undeformed state.

In the embodiment, the protrusion height of each support portion 60 from the end wall 13a of the motor housing member 13 may be equal to the protrusion height of the bead 53 from the first surface of the seal body 51 when the seal portion 50 is in an undeformed state.

In the embodiment, the seal portion 50 may be formed integrally with the support plate 42.

In the embodiment, for example, the inverter chamber 23 may be defined by a cylindrical cover body and a lid member. The cover body is separate from the motor housing member 13 and is coupled to the end wall 13a of the motor housing member 13. The cover body includes an opening, and the lid member closes the opening of the cover body. In this case, the end wall 13a and the bottom wall of the cover body serve as partition walls that separate the motor chamber S1 from the inverter chamber 23. The through-hole 24 extends through the end wall 13a and the bottom wall of the cover body.

In the embodiment, in the motor-driven compressor 10, for example, the inverter 25 may be located outward from the housing 11 in the radial direction of the rotary shaft 14. That is, the compression unit 15, the motor 16, and the inverter 25 do not have to be arranged in this order in the axial direction of the rotary shaft 14.

In the embodiment, the compression unit 15 is not limited to a scroll type. Instead, the compression unit 15 may be, for example, a piston type, a vane type, or a rotary type.

In the embodiment, the motor-driven compressor 10 is included in the vehicle air conditioner 21. However, the motor-driven compressor 10 may be used in other apparatuses. For example, the motor-driven compressor 10 may be mounted on a fuel cell electric vehicle and may use the compression unit 15 to compress air, which is a fluid supplied to the fuel cell.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A motor-driven compressor, comprising:
a compression unit configured to compress fluid;
a motor configured to drive the compression unit;
an inverter configured to drive the motor;
a housing including a motor chamber which accommodates the motor and into which fluid is drawn, an inverter chamber that accommodates the inverter, and a partition wall that separates the motor chamber from the inverter chamber; and
a hermetic terminal that electrically connects the motor to the inverter while blocking passage of fluid between the motor chamber and the inverter chamber, wherein
the partition wall has a through-hole,
the hermetic terminal includes:
a conductive member that passes through the through-hole, the conductive member having a first end electrically connected to the motor and a second end electrically connected to the inverter;
a support plate configured to support the conductive member;
a seal portion including an annular bead, the bead being configured to seal around the through-hole; and
a fastener configured to fasten the support plate to the partition wall,
a support portion is interposed between the support plate and the partition wall, and
the support portion is configured to support a portion of the support plate located on an opposite side of the fastener from the bead.

2. The motor-driven compressor according to claim 1, wherein
the support portion is formed integrally with the partition wall and protrudes from the partition wall toward the support plate.

3. The motor-driven compressor according to claim 1, wherein
the support portion is formed integrally with the support plate and protrudes from the support plate toward the partition wall.

4. The motor-driven compressor according to claim 1, wherein
the seal portion includes a flat seal body interposed between the support plate and the partition wall,
the bead protrudes from the seal body, and
the support portion is formed integrally with the seal portion and protrudes from the seal body in a same direction as the bead.

5. The motor-driven compressor according to claim 1, wherein
the support portion is separate from the partition wall, the support plate, and the seal portion.
